(19) United States
(12) Patent Application Publication
(10) Pub. No.: US 2014/0163716 A1
(43) Pub. Date: Jun. 12, 2014

(54) BRIDGE DEVICE, AUTOMATED PRODUCTION SYSTEM AND METHOD THEREOF FOR STORAGE DEVICE

(71) Applicant: SKYMEDI CORPORATION, HSINCHU CITY (TW)

(72) Inventors: SUNG-SAN CHANG, HSINNCHU CITY (TW); CHE-MING HSU, HSINCHU CITY (TW); PO-CHUN CHANG, HSINCHU CITY (TW)

(73) Assignee: SKYMEDI CORPORATION, HSINCHU CITY (TW)

(21) Appl. No.: 13/709,230

(22) Filed: Dec. 10, 2012

(51) Int. Cl. G05B 15/02

(52) U.S. Cl. CPC G05B 15/02
USPC 700/117

(57) ABSTRACT

A bridge device for manufacturing a storage device, including a first transmission interface, a second transmission interface, a mode select unit, a power control unit, and a bridge controller is provided. The mode select unit generates a mode select signal responsive to a manufacturing process command. The power control unit controls powering operation of the storage device. The bridge controller receives the manufacturing process command through the first transmission interface. When the bridge controller detects the presence of the storage device, drives the power control unit turning off the storage device. After a first predetermined period, the bridge controller drives the mode select unit transmitting the mode select signal to the storage device through unused pin of the second transmission interface. The bridge controller drives the power control unit turning on the storage device after a second predetermined period to have the storage device entering a predefined mode.

### BACKGROUND

1. Technical Field

The present disclosure relates to a bridge device, a system, and a method thereof for manufacturing storage device in particular, to a bridge device, a system, and a method thereof for automatically manufacturing a storage device.

2. Description of Related Art

In practice, at least a low-level format process (or open card process) and series of flash memory read/write tests must be performed on a flash storage device before it is ready for the end-user to use. In the process of low-level format, manufacturers determine and record the defect block(s) according to the data stored in spare area of the flash storage device provided by the factory. During the process of low-level format, firmware such as read/write control parameters, block management algorithm related parameters, and manufacturing parameters are further correspondingly recorded in the system block and logic to physical mapping table to prevent writing data into the defect blocks causing data loss. Flash memory read/write tests are performed to locate blocks that are vulnerable becoming defect blocks. Accordingly, the flash storage device related factory acceptance tests are often an important manufacturing procedure that decides the quality of the flash storage device.

In current manufacturing system setting of flash storage device, flash storage devices are electrically connected to a host through a production tool (or production fixture) to perform various manufacturing processes. In particular, the manufacturing process of low-level format is currently performed through hardware configuration. In one of the conventional schemes, a jumper is installed on the flash storage device. In particular, in the process of performing low-level format, operators are required to manually switch the jumper to a low-level format mode (i.e. electrically grounded) and manually switch the jumper back to the normal mode (i.e. electrically connects to power) after completed the process of low-level format. However, the described scheme not only incurs cost of installing jumper on the flash storage device but also prone to human errors e.g., forgetting to switch back the jumper back resulting in the flash storage device continue staying in low-level format state. Further, the jumper in practice is installed inside the flash storage device so that operators generally have to disassemble the flash storage device for the access of the jumper. Additionally, since the jumper by its nature has certain height, such that is not suitable for flash storage devices having thin form factor.

Another conventional scheme for performing the process of low-level format is by employing a bridge device having predefined mode setting e.g., a bridge device hardwired to the low-level format mode or a bridge device hardwired to the normal mode. This scheme requires manual operations including manually resetting the state of the flash storage device to the normal mode through manually configuring the powering operations and connecting the flash storage devices to different bridge devices with appropriate mode at respect manufacturing stations in order to proceed with the corresponding manufacturing processes. Since a single bridge device can only drive the flash storage device to operate in a single operating mode at one station, the objective of multiple manufacturing processes at one station cannot be accomplished. Moreover, the conventional scheme is also vulnerable to human errors and does not support automatically manufacturing and testing processes such as firmware loading, low-level format, and read/write tests at one station.

Consequently, in the conventional flash storage device manufacturing setting, manual operations and separate processing stations are required to manufacture a flash storage device which cannot meet the current manufacturer demands of automatically manufacturing flash storage device. Hence, the current flash storage device manufacturing system is inefficient and may not keep up with the increasing manufacturing volume of flash storage device production.

### SUMMARY

Accordingly, an exemplary embodiment of the present disclosure provides a bridge device, a system and a method thereof for automatically manufacturing the storage device e.g., solid-state drive (SSD). The bridge device, a system and a method thereof provided can actively detect the presence of the storage device and automatically drive the storage device into various operating modes through firmware and hardware integration so as to execute various necessary manufacturing processes. Accordingly, manufacturing processes requiring different operating modes can be performed in a single station without the need to change or manually configuring the production tool thereby increase the production efficiency while eliminate the possibility of human error.

An exemplary embodiment of the present disclosure provides a bridge device for automatically manufacturing at least a storage device. The bridge device includes a first transmission interface, a second transmission interface, a mode select unit, a power control unit, and a bridge controller. The first transmission interface is coupled to a host for receiving a manufacturing command generated by the host. The second transmission interface is coupled to the storage device. The mode select unit is coupled to the second transmission interface and outputs a mode select signal responsive to the manufacturing command. The power control unit is used for controlling the powering operation of the storage device. The bridge controller is coupled to the first transmission interface. The bridge controller receives the manufacturing command and operatively controls the operations of the mode select unit and the power control unit according to the manufacturing command. When the bridge controller detects the presence of the storage device through the second transmission interface, the bridge controller drives the power control unit turning off the storage device. The bridge control controls the mode select unit transmitting the model select signal to the storage device through at least an unused pin of the second transmission interface after a first predetermined period, and drives the power control unit turning on the storage device after a second predetermined period to have the storage device entering an operating mode according to the mode select signal so as to automatically execute a manufacturing process in corresponding to the manufacturing command.

An exemplary embodiment of the present disclosure provides an automated manufacturing system. The automated manufacturing system includes a host, at least a storage device, and a bridge device. The host generates a manufacturing command. The bridge device is coupled between the host and the storage device. The bridge device includes a first transmission interface, a second transmission interface, a mode select unit, a power control unit, and a bridge controller. The first transmission interface is coupled to a host for receiving a manufacturing command generated by the host. The second transmission interface is coupled to the storage device. The mode select unit is coupled to the second transmission interface and outputs a mode select signal responsive to the manufacturing command. The power control unit is used for controlling the powering operation of the storage device. The bridge controller is coupled to the first transmission interface. The bridge controller receives the manufacturing command and operatively controls the operations of the mode select unit and the power control unit according to the manufacturing command. When the bridge controller detects the presence of the storage device through the second transmission interface, the bridge controller drives the power control unit turning off the storage device. The bridge control controls the mode select unit transmitting the model select signal to the storage device through at least an unused pin of the second transmission interface after a first predetermined period, and drives the power control unit turning on the storage device after a second predetermined period to have the storage device entering an operating mode according to the mode select signal so as to automatically execute a manufacturing process in corresponding to the manufacturing command.

An exemplary embodiment of the present disclosure provides an automated manufacturing method for automatically manufacturing at least a storage device. The automated manufacturing method can be adapted for an automated manufacturing system. The automated manufacturing system includes a host, at least a storage device, and a bridge device, wherein the bridge device is coupled between the host and the storage device. The automated manufacturing method includes step of the bridge device detecting whether or not the storage device is connected to the bridge device and executing a manufacturing command when the storage device is connected to the bridge device; the bridge device detecting whether or not a manufacturing process corresponding to the manufacturing command can be performed; the bridge device transmitting a mode select signal driving the storage device into an operating mode when the storage device is unable to perform the manufacturing process; the bridge device loading the data sent by the host into the storage device when the storage device has entered the operating mode to have the storage device executing the manufacturing process.

To sum up, an exemplary embodiment of the present disclosure provides a bridge device, an automated manufacturing system and a method thereof which can through using a hardware/firmware integrated bridge device coordinate the communication between a host and at least a storage device to automatically manufacture the storage device. The bridge device, the automated manufacturing system, and the method thereof may utilize firmware design control method automatically driving the storage device into various operating mode e.g., a low-level format mode, a normal mode, a high performance or a green power mode in correspondence to the manufacturing process. The present disclosure through utilize hardware/firmware designed bridge device can facilitate the automated manufacturing system in automatically performing all the necessary manufacturing processes to a storage device at one production line without the need to manually configure the operating mode of the storage device via replacing the bridge device or modifying the hardware structure of the storage device. Consequently, the overall production efficiency can be increase while overall production complexity and cost can be reduced.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of an automated manufacturing system provided in accordance to an exemplary embodiment of the present disclosure.

FIG. 2 is a block diagram illustrating an automated manufacturing system provided in accordance to another exemplary embodiment of the present disclosure.

FIG. 3 is a block diagram illustrating an automated manufacturing system provided in accordance to a further exemplary embodiment of the present disclosure.

FIG. 4 is a block diagram illustrating an automated manufacturing system provided in accordance to another exemplary embodiment of the present disclosure.

FIG. 5 is a block diagram illustrating an automated manufacturing system for manufacturing multiple storage device provided in accordance to another exemplary embodiment of the present disclosure.

FIG. 6 depicts an automated manufacturing method provided in accordance to one exemplary embodiment of the present disclosure.

FIG. 7 depicts a low-level format mode enforcing method provided in accordance to one exemplary embodiment of the present disclosure.

FIG. 8 is a timing diagram illustrating the method described in FIG. 7 provided in accordance to the exemplary embodiment of the present disclosure.

FIG. 9 depicts another low-level format mode enforcing method provided in accordance to an exemplary embodiment of the present disclosure.

FIG. 10 is a timing diagram illustrating the method described in FIG. 9 provided in accordance to the exemplary embodiment of the present disclosure.

FIG. 11 depicts method for resetting the flash controller of the storage device provided in accordance to one exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

(An Exemplary Embodiment of Automated Manufacturing System for Manufacturing Storage Device)

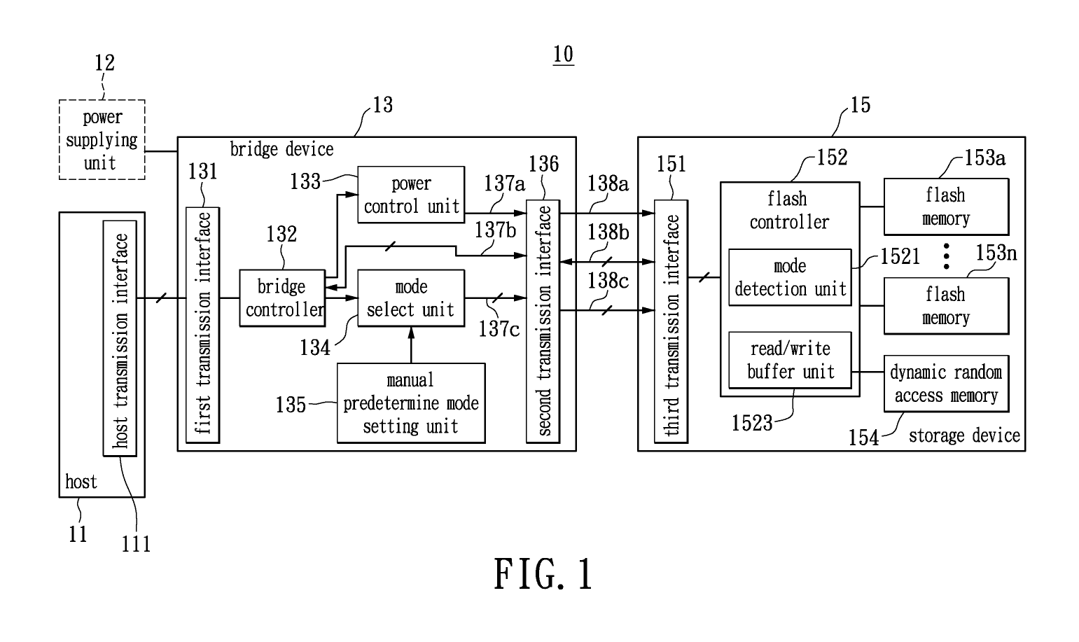

Please refer to FIG. 1, which shows a block diagram illustrating an automated manufacturing system for automatically manufacturing a storage device provided in accordance to the present disclosure. The disclosed automated manufacturing system 10 can automatically switch the storage device between various operating modes (e.g., normal mode and low-level format mode) and perform related manufacturing processes at one production line without the need to manually configure the hardware structure of a storage device or change the production tool connected between the host and the storage device.

In the instant embodiment, the automated manufacturing system 10 includes a host 11, a power supplying unit 12, a bridge device 13, and a storage device 15. The power supplying unit 12 is coupled to the bridge device 13. The bridge device 13 is coupled between the host 11 and the storage device 15. The bridge device 13 may be used to coordinate the communication between the host 11 and the storage device 15 so as to perform various manufacturing processes to manufacture the storage device 15.

The hose 11 has a manufacturing process control interface (not shown) displayed thereon for configuring and performing the manufacturing processes associated with the storage device 15. Specially, the operator of the host 11 may configure the manufacturing parameters and the manufacturing process flow in corresponding to the storage device 15 through the manufacturing process control interface. The host 11 may be a computing device such as a desktop or a laptop with the automated manufacturing program code stored therein. The manufacturing process control interface may be generated by having the processor (not shown) of the computing device executing the automated manufacturing program code stored in the memory unit (not shown) thereof.

The power supplying unit 12 is used to provide necessary power for powering the bridge device 13. In one implementation, the power supplying unit 12 can be integrated inside the host 11 and can provide power to the bridge device 13 after the host 11 electrically connects the bridge device 13. In another implementation, the power supplying unit 12 may be implemented by a power supply which can provide the necessary power to the bridge device 13 through a power cable. However, the instant embodiment does not limit the actual implementation method for the power supplying unit 12.

The bridge device 13 can coordinate communication between the host 11 and the storage device 15 such that the host 11 can automatically perform manufacturing processes including but not limited to firmware writing, low-level format, and read/write tests on the storage device 15 through bridge device 13 according to the user configurations on the manufacturing process control interface. The bridge device 13 may actively detect the presence of storage device 15 through an interface having hot plugging capability and automatically drive the storage device 15 into various operating mode so as to execute corresponding manufacturing process.

The storage device 15 may be a fixed storage device including but not limited to hard disk drive (HDD), solid-state drive (SDD), hybrid disk drive, optical disk drive (ODD), magnetic optical drive, flash disk, and phase change disk. The storage device 15 may also be a pluggable storage device including but not limited to PCI Express, Secure Digital (SD) card, Memory Stick (MS), Compact Flash (CF), Multi-Media-Card (eMMC), IDE, and SATA flash memory devices. However the present disclosure is not limited to the example provide herein.

The host 11 further includes a host transmission interface 111. The host 11 establishes communication with the bridge device 13 through the host transmission interface 111 so as to drive the bridge device 13 configuring the operating mode (e.g., low-level format mode or normal mode) of the storage device 15 for automatically implementing various manufacturing process e.g., low-level format or read/write tests.

The bridge device 13 includes a first transmission interface 131 (i.e., front-end interface), a bridge controller 132, a power control unit 133, a mode select unit 134, a manual predetermine mode setting unit 135, and a second transmission interface 136 (back-end interface). The first transmission interface 131 is coupled to the bridge controller 132. The bridge controller 132 is coupled to the power control unit 133 and the mode select unit 134. The power control unit 133 and the mode select unit 134 are respectively coupled the second transmission interface 136 through buses 137a and 137c. The bridge controller 132 is further coupled to the second transmission interface 136 through a bus 137b. The manual predetermine mode setting unit 135 is coupled to the mode select unit 134.

The bridge device 13 is electrically connected to the host 11 through the first transmission interface 131 and is electrically connected to the storage device 15 through the second transmission interface 136. In other words, the first transmission interface 131 is used as the data transferring interface between the host 11 and the bridge device 13 and the second transmission interface 136 is used as the data transferring interface between the bridge device 13 and the storage device 15.

The bridge controller 132 through the first transmission interface 131 receives the data (e.g., manufacturing command, firmware data, lower-level format parameters, manufacturing parameters, read/write control parameters or read/write data) sent by the host 11 via the host transmission interface 111. The bridge controller 132 has a programmable production control program, wherein the programmable production control program is used to coordinate with the automated manufacturing program for performing the manufacturing processes associated with the storage device 15. The bridge controller 132 may transmit the firmware data or read/write data to the storage device 15 through bus 137b, the second transmission interface 136, and the bus 138b while executing the programmable production control program. The bridge controller 132 further may correspondingly control the operations of the power control unit 133 and the mode select unit 134 to switch the operating modes of the storage device 15 and to perform various manufacturing processes. The power control unit 133 can convert the input voltage provided by the power supplying unit 12 into the operating voltage of the storage device 15 and provide to the storage device 15 via the second transmission interface 136. To put it concretely, the power control unit 133 can convert the input voltage into voltage compatible to the interface standard of the storage device 15 so as to properly control the powering operation of the storage device 15.

For instance, supposing the storage device 15 is equipped with transmission interface of SATA standard, the power control unit 133 may thus perform boost or buck conversion to convert input voltage into 5V qualifying SATA standard and supply to the storage device 15 accordingly. For another instance, supposing the storage device 15 is equipped with transmission interface of micro SATA standard, the power control unit 133 then converts the received input voltage into 3.3V and supply to the storage device 15.

The bridge controller 132 therefore can through the power control unit 133 selectively power up or power down the storage device 15 and reset the storage device 15. In practice, the power control unit 133 may be implemented by a DC to DC conversion circuit e.g., buck converter or low voltage drop regulator, however the present disclosure is not limited thereto.

The mode select unit 134 is used for generating a mode select signal responsive to a manufacturing command in corresponding to a manufacturing process. The mode select unit 134 further transmits the mode select signal to the storage drive 15 through at least an unused pin of the second transmission interface 136 to correspondingly drive the storage device 15 entering the operating mode (e.g., normal mode or low-level format mode) associated with the manufacturing process. The functionality of the unused pins of the second transmission interface 136 may be configured through firmware design.

It is worth to note that the mode select unit 134 may through varying the voltage level or the frequency of the mode select signal configure the operating mode of the storage device 15. The high and the low voltage level of the mode select signal may be set according to the required operating voltage of the storage device 15.

The bridge device 13 further includes manual predetermine mode setting unit 135 for pre-configuring the mode select signal to a mode select signal indicating the low level format mode (e.g., a mode select signal having high voltage level) or a mode select signal indicating normal mode (e.g., a mode select signal having low voltage level). Such that when the storage device 15 connects to the second transmission interface 136, the bridge device 13 instantly outputs the predefined mode select signal to the storage device 15 through at least an used pin of the second transmission interface 136 so as to automatically drive the storage device 15 entering the predefined operating mode e.g., the low-level format mode or the normal mode.

Moreover, the storage device 15 includes a third transmission interface 151, flash controller 152, flash memory 153a˜153n, and dynamic random access memory (DRAM) 154. The flash controller 152 is coupled to the third transmission interface 151, flash memory 153a˜153n, and DRAM 154.

Specifically, the third transmission interface 151 is electrically connected to the second transmission interface 136 of the bridge device 13 through a bus 138a (e.g., power bus line), a number of buses 138b (e.g., data bus line), and at least a bus 138c (e.g., mode control bus line). Particularly, the flash controller 152 of the storage device 15 may through the third transmission interface 151 and the bus 138a receive the power provided by the bridge device 13. The flash controller 152 of the storage device 15 may receive the mode select signal outputted by the bridge device 13 through at least a bus 138c and the third transmission interface 151. The flash controller 152 of the storage device 15 may further receive data (e.g., read/write data, firmware data, control parameters, and manufacturing parameters) transferred from the host 11 through a number of buses 138b and the third transmission interface 151.

The flash controller 152 having a programmable production processing program stored therein can be used to identify the mode select signal and to switch between operating modes accordingly so as to perform corresponding manufacturing process. The programmable production processing program can control data access operation of the flash memory 153a˜153n and the DRAM 154 during the manufacturing process. The programmable production processing program may be implemented by having the flash controller 152 executes the related programmable production processing program code.

The flash controller 152 further includes a mode detection unit 1521 and read/write buffer unit 1523. The mode detection unit 152 can detect and identify the mode select signal and drive the storage device 15 entering the corresponding operating mode as the storage device 15 connected to the bridge device 13. In one implementation, the mode detection unit 1521 may through detect the voltage level of the bus 138c and search the predefined look-up table file, determining the operating mode responsive to the mode select signal. Additionally, the predefined look-up table file prestored in the flash controller 152 may include the mode select signal and the corresponding operating mode switching instruction. The predefined look-up table file may be integrated in the flash controller 152 via firmware design.

The read/write buffer unit 1523 can facilitate the data access operation between the flash controller 152 and the DRAM 154. The read/write buffer unit 4523 may be implemented through firmware design and programmed in the flash controller 152, however the instant embodiment is not limited thereto.

Next, the overall explanation on the operation of the automated manufacturing system 10 is provided.

When the bridge controller 132 detects the presence of the storage device 15 through the second transmission interface 136 (i.e., detects that a storage device 15 has connected to the second transmission interface 136), the bridge controller 132 immediately through the first transmission interface 131 notifies the host 11. Subsequently, the operator of the host 11 may issue a manufacturing command e.g., low-level format manufacturing command via the manufacturing process control interface. Upon receiving the manufacturing command, the bridge controller 132 first detects whether or not the storage device 15 can execute the manufacturing command i.e., low-level format manufacturing command and proceed with the corresponding low-level format manufacturing process.

In particular, the bridge controller 132 may through the second transmission interface 136 and the bus 138c transmit a mode verification signal to the storage device 15. The flash controller 152 of the storage device 15 may response with an operating mode signal indicating the current operating mode to the bridge device 13 through the third transmission interface 151 and at least a bus 138b (e.g., data bus line). When the bridge controller 132 determines that the storage device 15 can execute the low-level format manufacturing process (i.e. the storage device 15 operates in the low-level format mode) according to the operating mode signal, the bridge controller 132 notifies the host 11 to proceed with firmware downloading and control and manufacturing parameters writing operations.

Conversely, if no response has been received by the bridge device 13 or the operating mode signal indicating that the storage device 15 is in normal mode, the bridge controller 132 forces the storage device 15 entering the low-level format mode. Specifically, the bridge controller 132 first drives the power control unit 133 to turn off the storage deice 15. In other words, the bridge controller 132 can control the power control unit 132 cease supplying power to the storage device 15 driving the storage device 15 into complete power-off state to reset the storage device 15. After delayed for a predetermined period, the bridge controller 132 drive the mode select unit 134 outputting a mode select signal in corresponding to the low-level format mode to the storage device 15 through at least an unused pin of the second transmission interface 136. Meanwhile, the bridge controller 132 drives the power control unit 133 to start powering the storage device 15. When the flash controller 152 restarts, the flash controller 152 detects and identifies that the mode select signal corresponds to the low-level format mode switching instruction, instantly drive the storage device 15 entering the low-level format and executing the related low-level format manufacturing process.

It is worth to note that as described previously, conventional production tool or fixture in practice is hardwired to a predefined operating mode so that at the instant that the production tool or fixture is connect to the storage device, a predefined mode driving signal with high voltage level (e.g. 3.3V) is instantly outputted causing power leakage, leading to the program counter of the storage device malfunction and further affect overall system stability. Accordingly, in the instant embodiment, the bridge controller 132 of the bridge device 13 through turns off the storage device 15 after establishing links with the storage device 15, turns on the storage device 15 after a period of time, and transmits the mode select signal can thereby eliminate the power leakage resulting in system instability problem of the conventional method.

The first transmission interface 131 of the bridge device 13 is compatible with the host transmission interface 111 of the host 11. The type of the host transmission interface 111 and the first transmission interface 131 may include but not limited to universal serial bus (USB) interface, an IEEE 1394 interface, a SATA interface, an eSATA interface, and a micro SATA interface.

The second transmission interface 136 of the bridge device 13 is compatible with the third transmission interface 151 of the storage device 15. The type of the second transmission interface 136 and the third transmission interface 151 may include but not limited to an integrated drive electronic (IDE) standard, a SATA standard, a micro SATA standard, a Small Computer System Interface (SCSI) stands, a flash interface standard, or a ZIP standard. It shall be noted that the actual type and implementation method of the host transmission interface 111, the first transmission interface 131, the second transmission interface 136, and the third transmission interface 151 depend upon the specific design and/or operational requirement and shall not be limited to the examples provided by the instant embodiment.

Further, the implementation of the host 11, the power supplying unit 12, the bridge device 13, and the storage device 15 may depend upon the actual design of the automated manufacturing system 10 and shall not limited by the present disclosure. Similarly the power control unit 133 and the mode select unit 134 may be implemented through firmware design or hardware circuitry design and shall not be limited by the present disclosure.

Additionally, the bridge controller 132 of the bridge device 13 and the flash controller 152 of the storage device 15 may be implemented by processing chips including but not limited to central processing unit, microcontroller and/or embedded controller having specific firmware design, however the present disclosure is not limited thereto. Furthermore, it shall be noted that the number of the storage device 15 is not limited, and the number of the storage device 15 in practice may be larger than 2, such that a plurality of the storage devices 15 can be manufactured at once. Therefore, FIG. 1 only serves as an illustration of a system block diagram for an automated manufacturing system and the present disclosure shall not be limited hereto.

(An Exemplary Embodiment of Automated Manufacturing System for Manufacturing Storage Device)

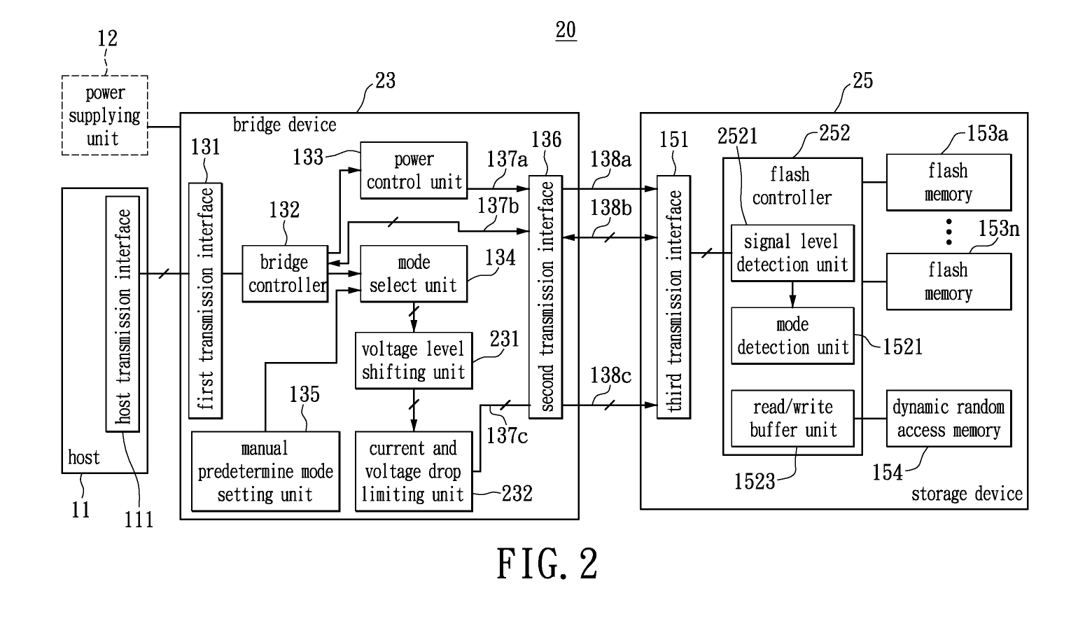

Please refer to FIG. 2 in conjunction with FIG. 1, wherein FIG. 2 shows a block diagram illustrating an automated manufacturing system provided in accordance to another exemplary embodiment of the present disclosure. The automated manufacturing system 20 includes a host 11, a bridge device 23, and a storage device 25. The basic structure and operation theory of the automated manufacturing system 20 is the same as the automated manufacturing system 10. The automated manufacturing system 20 operates to automatically perform various manufacturing processes (e.g., low-level format or read/write test) on the plugged storage device 25. The difference between the automated manufacturing system 20 in FIG. 2 and the automated manufacturing system 10 in FIG. 1 is in the structure of the bridge device 23 and the storage device 25.

The bridge device 23 in the instant embodiment further includes a voltage level shifting unit 231 and a current and voltage drop limiting unit 232. The voltage level shifting unit 231 is coupled to the mode select unit 134 and the current and voltage drop limiting unit 232 is coupled to the voltage level shifting unit 231.

It is well known in the art that the voltage level of the signal pins is not necessary the same as that of the power pins. The voltage level shifting unit 231 is thus included to convert the voltage level of the mode select signal outputted by the mode select unit 134 according to the manufacturing command into the voltage level that is compatible with the signal pins of the third transmission interface 151 configured to receive the mode select signal.

The current and voltage drop limiting unit 232 can be used to limit the flow of current in the mode select signal path when flash controller 152 is powered off. In particular, the current and voltage drop limiting unit 232 limits the current of the mode select signal that flows through the bus 137c, the second transmission interface 136, and the bus 138c so as to prevent misjudgment due to power leakage causing the storage device 25 to be malfunction.

The mode detection unit 1521 of the storage device 25 is coupled to the signal level detection unit 2521. The signal level detection unit 2521 can be used to detect the voltage level of the mode select signal (e.g., high voltage level or low voltage level) outputted from the bridge device 23 through the path of at least the bus 137c, the second transmission interface 136, and the bus 138c. The signal level detection unit 2521 outputs the detection result to the mode detection unit 1521 to have the mode detection unit 1521 identifying the operating mode switching instruction associated with the mode select signal so as to have the flash controller 252 driving the storage device 25 entering the operating mode (i.e., low-level format mode) in corresponding to the operating mode switching instruction.

For instance, suppose the manufacturing command being the low-level format manufacturing process, when the bridge device 23 needs to force the storage device 25 entering the low-level format mode, the bridge controller 132 may operatively control the power control unit 133 to cut off the power supplied to the storage device 25 and drive the mode select unit 134 to output the corresponding mode select signal (i.e., the mode select signal indicating low-level format mode). In the instant embodiment, the mode select signal indicating the low-level format mode may be a high voltage level signal. The voltage level shifting unit 23 converts the voltage level of the mode select signal into the voltage level (e.g., 5V) which is compatible to the signal pins of the third transmission interface 151 (e.g., compatible with SATA interface standard). The signal level detection unit 2521 determines the voltage level of the received mode select signal to have the mode detection unit 1521 identifying the corresponding operation mode switching instruction and have the flash controller 252 driving the storage unit 25 entering the low-level format mode.

The rest of system operation and structure of the automated manufacturing system 20 is essentially the same as the automated manufacturing system 10. Based on the above elaborations, those skilled in the art should be able to understand the operation of the automated manufacturing system 20 as well as deduce other configurations of the automated manufacturing system structures, and further descriptions are hereby omitted. It is worth to note that the implementation of the host 11, the power supplying unit 12, the bridge device 23, and the storage device 25 may depend upon the actual design of the automated manufacturing system 20 and shall not limited by the present disclosure. Similarly, the voltage level shifting unit 231 and the current and voltage drop limiting unit 232 may be implemented and integrated in the bridge device 23 using hardware circuitry such as voltage regulator circuit and current limiting circuit. The signal level detection unit 2521 may be integrated in the flash controller 252 through firmware design. However, the present disclosure does not limit the actual implementation structure and method associated with the voltage level shifting unit 231, the current and voltage drop limiting unit 232, and the signal level detection unit 2521. FIG. 2 only serves as an illustration of a system block diagram for an automated manufacturing system and the present disclosure shall not be limited hereto

(An Exemplary Embodiment of Automated Manufacturing System for Manufacturing Storage Device)

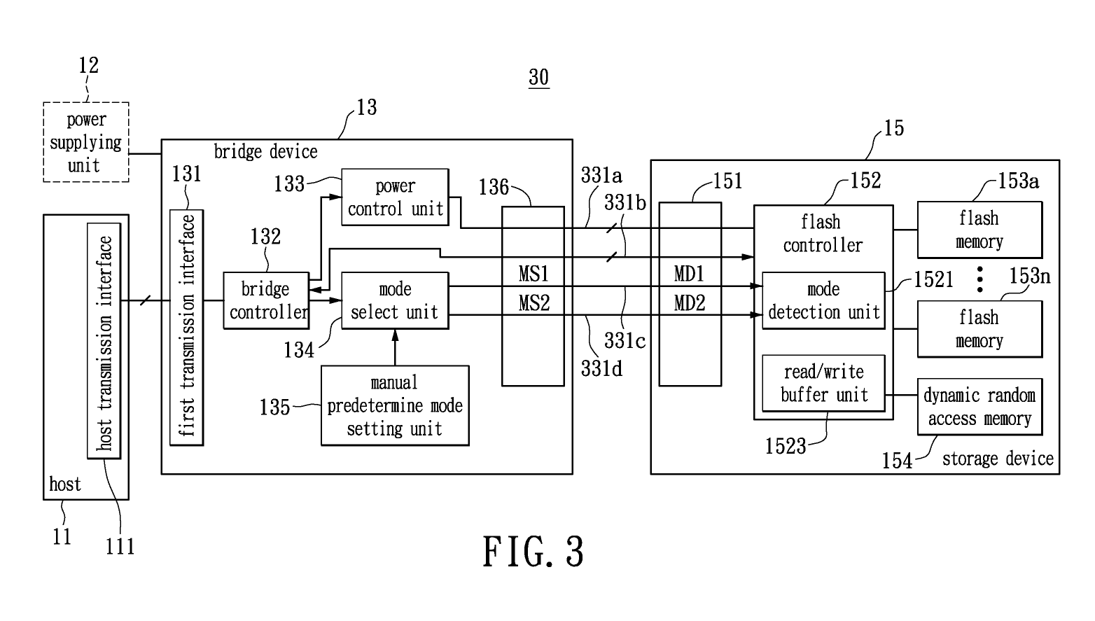

Please refer to FIG. 3 in conjunction with FIG. 3, in which FIG. 3 shows a block diagram illustrating an automated manufacturing system provided in accordance to a further exemplary embodiment of the present disclosure. The basic structure and operation theory of the automated manufacturing system 30 is the same as the automated manufacturing system 10. The automated manufacturing system 30 operates to automatically perform various manufacturing processes on the plugged storage device 25.

In the instant embodiment, the second transmission interface 136 of the bridge device 13 and the third transmission interface 151 of the storage device 15 adopt the SATA interface standard. FIG. 3 shows only partial pins defined in the interface standard for illustrative purpose. It is well known in the art that the SATA interface standard typically includes two segments i.e., the signal segment and the power segment, the pin put of which is shown in the following table 1.

| Pin Name | Pin Function |
|---|---|
| S1 | GND |
| S2 | A+ |
| S3 | A− |
| S4 | GND |
| S5 | B− |
| S6 | B+ |
| S7 | GND |
| P1 | V33 |
| P2 | V33 |
| P3 | V33 |
| P4 | GND |
| P5 | GND |
| P6 | GND |
| P7 | V5 |
| P8 | V5 |
| P9 | V5 |
| P10 | GND |
| P11 | DAS |
| P12 | GND |
| P13 | V12 |
| P14 | V12 |
| P15 | V12 |

As listed in table 1, pin S1˜pin S7 are in the signal segment and are used for data transmission purpose including but not limited to firmware transmission, manufacturing parameters, read/write control parameters, and read/write data transmission. The pin P1˜pin P15 are in the power segment and are used for transmitting power.

In general, some of the pins in the power segment such as pin P1˜pin P3 and pin P13˜pin P15 are unused pin. Thus in the instant embodiment, these pins (e.g., P1˜P3 and P13˜P15) can be configured for mode select signal transmission and detection purposes through individual firmware design on the bridge controller 132 of the bridge device 13 and the flash controller 152 of the storage device 15.

For instance, pin P1 and pin P2 from the unused pins of the second transmission interface 136 can be configured as mode select pin MS1 (i.e., the first mode select pin) and mode select pin MS2 (i.e., the second mode select pin); pin P1 and pin P2 from the unused pins of the third transmission interface 151 can be configured as mode detection pin MD1 (i.e., the first mode detection pin) and mode detection pin MD2 (i.e., the second mode detection pin).

More specifically, the power control unit 133 of the bridge device 13 may through pins P4˜P12 of the second transmission interface 136 and a number of corresponding buses 331a electrically connect to the corresponding pins of the third transmission interface 151 so as to supply power to the storage device 15. The bridge controller 132 of the bridge device 13 may through pins S1˜S7 and a number of buses 331b electrically connect to the corresponding pins of the third transmission interface 151 so as to transmit the data corresponding to different manufacturing process to the storage device 15 using STAT standard data format.

The mode select unit 134 of the bridge device 13 may respectively output two signals with identical or different voltage levels to the mode select pin MS1 and MS2 to form the mode select signal according to a predefined look-up table file stored in the bridge controller 132. The mode detection pins MD1 and MD2 of the third transmission interface 151 may respectively electrically connect to the mode select pins MS1 and MS2 through buses 331c and 331d for receiving and outputting the mode select signal to the mode detection unit 1521.

The mode detection unit 152 further can search a corresponding operating mode switching instruction according to a predefined look-up table file stored in the flash controller 152 so as to drive the storage device 15 into the corresponding operating mode. Additionally, the predefined look-up table file stored in the flash controller 152 may include the voltage level pattern of the mode detection pins MD1 and MD2 and the corresponding operating mode switching instruction. The predefined look-up table file stored in the bridge controller 132 may include may include the mode select signal, corresponding operating mode, and the associated manufacturing process.

It is worth to note that different voltage level combination of the mode select pins MS1 and MS2 can correspond to different operating modes and are configured in the bridge controller 152 via firmware design. To put it concretely, the mode select pins MS1 and MS2 collectively can produce four different combination hence is capable of driving the storage device 15 entering four different operating modes including the low-level format mode, the normal mode, the high performance mode, the green power mode so as to perform various manufacturing processes.

Taking low-level format mode as an illustrative example, supposing the bridge controller 132 in responsive the low-level format manufacturing command operates to drive the storage device 15 entering the low-level format mode. Regardless the current state which the mode select pins MS1 and MS2 are in, upon receiving the low-level format manufacturing command, the bridge device 13 controls the power control unit 133 cutting off the power of the storage device 15. Subsequently, after a first predefined period (e.g., 1 sec), the bridge controller 13 may configure the mode select unit 134 setting the mode select pin MS2 low (e.g., 0V). After delayed again for a second predefined period (e.g., 1 sec) the bridge controller 13 may configure the mode select unit 134 setting the mode select pin MS1 high (e.g., 5V). At the same time, the bridge device 13 controls the power control unit 13 to start powering the storage device 15.

Incidentally, the voltage level of the mode select pins MS1 and MS2 are defined according to the SATA interface standard and may be user configured on the manufacturing process control interface (not shown) provided in the host 11 or predefined in the firmware of the bridge controller 132 or preconfigured using hardware circuitry, the present disclosure is not limited thereto.

Referring back to the low-level format mode example, when the storage device 15 restarts, the mode detection unit 1521 of the flash controller 152 may instantly detect that the mode detection pin MD1 being high voltage level and the mode detection pin MD2 being low voltage level. The mode detection unit 1521 further identify that the combination of having the mode detection pin MD1 being high voltage level and the mode detection pin MD2 being low voltage level corresponds to the low-level format mode switching instruction using the predefined look-up table file of the flash controller 152. The flash controller 152 may thereby successfully force the storage device 15 entering the low-level format mode and executes the related low-level format processes.

It is worth to note that the first predetermined period is for enabling the flash controller 152 of the storage device 15 to be in the completely off state to have the capacitor thereof completely discharge so as to reset the storage device 15. The second predetermined period is defined as the rising time of the mode detection pin MD2 for stabilizing the voltage level of the mode detection pin MD2. The first predetermined period and the second predetermined period may be implemented through firmware design onto the bridge controller 132 or may be user-configured through the manufacturing process control interface of the host 11. Based on the above elaborations, those skilled in the art should be able to infer the configuration and implementation method for the first predetermined period and the second predetermined period and further descriptions are hereby omitted.

Moreover, the rest of system operation and structure of the automated manufacturing system 30 is essentially the same as the automated manufacturing system 10. Based on the above elaborations, those skilled in the art should be able to understand the operation of the automated manufacturing system 30 as well as deduce other configurations of the automated manufacturing system structures, and further descriptions are hereby omitted.

Additionally, although the instant embodiment uses pin P1 and P2 from the SATA interface as the mode select pin MS1 and mode select pin MS2 for outputting the mode select signal, however in practice, any two pins from P13˜P15 can be used as the mode select pins through firmware configuration and the present disclosure is not limited thereto. Similarly, Although SATA interface standard is specifically illustrated in the instant embodiment for the second transmission interface 131 and the third transmission interface 151, it is appreciated that the described pin configuration concept can be easily applied to other interface standard such as eSTATA interface standard, micro SATA interface standard or Small Computer System Interface standard. Accordingly, FIG. 3 only serves as an illustration of a system block diagram for an automated manufacturing system and the present disclosure shall not be limited hereto.

(An Exemplary Embodiment of Automated Manufacturing System for Manufacturing Storage Device)

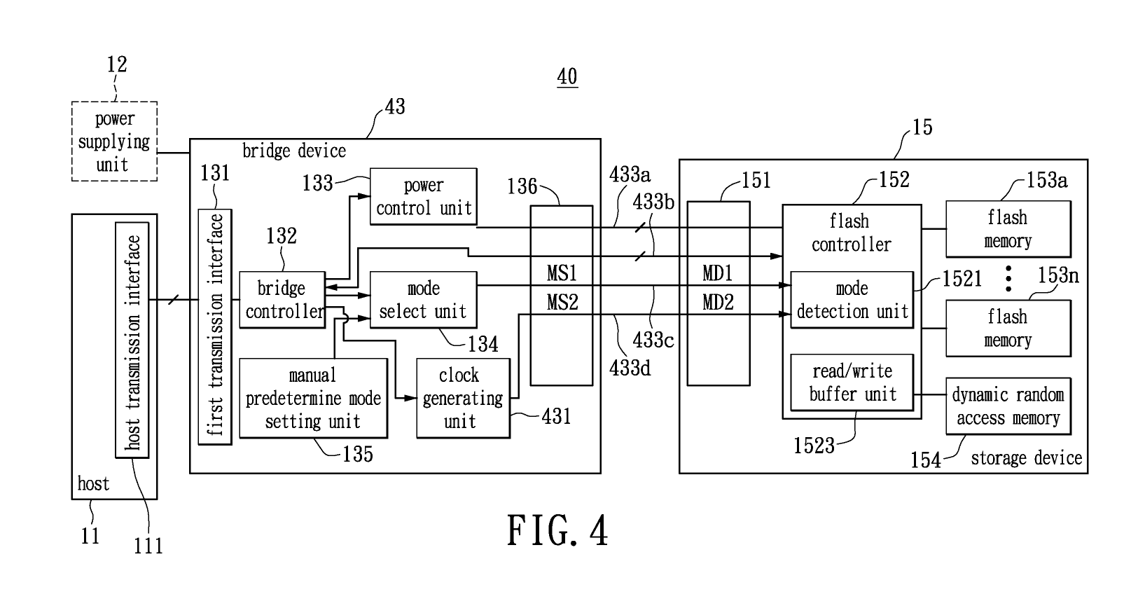

The aforementioned mode select signal for driving storage device 15 into various operating mode may also be implemented with single mode select pin. Please refer to FIG. 4 in conjunction to FIG. 3, in which FIG. 4 shows a block diagram illustrating an automated manufacturing system provided in accordance to another exemplary embodiment of the present disclosure. The basic structure and operation theory of the automated manufacturing system 40 is the same as the automated manufacturing system 30.

The automated manufacturing system 40 includes the host 11, a bridge device 43, and the storage device 15. The bridge device 43 is coupled between the host 11 and the storage device 15 for coordinating communication between the host 11 and the storage device 15 so as to perform related manufacturing process to produce the storage device 15.

The second transmission interface 136 of the bridge device 43 and the third transmission interface 151 also adopt SATA interface standard. In the instant embodiment, similar to the previous embodiment, pin 1 and pin P2 from the unused power pins P1˜P3 and P13˜P15 of the second transmission interface 136 are configured as the mode select pin MS1 and the mode select pin MS2, respectively; pin 1 and pin P2 from the unused power pins P1˜P3 and P13˜P15 of the third transmission interface 151 are configured as the mode detection pin MS1 and the mode detection pin MS2, respectively.

The power control unit 133 of the bridge device 43 may through a portion of power pins e.g., pin P4˜P13 and a number of buses 4331a electrically connect to the corresponding pins on the third transmission interface 151 for supplying power to the storage device 15. The bridge controller 132 of the bridge device 13 may through pins S1˜S7 and a number of buses 433b electrically connect to the corresponding pins of the third transmission interface 151 so as to transmit the data corresponding to different manufacturing process to the storage device 15 using STAT standard data format. The bridge controller 132 of the bridge device 43 may perform data access operations to the flash memory 143a˜153b and the dynamic random access memory (DRAM) 154 of the storage device 15.

The difference between the automated manufacturing system 40 in FIG. 4 and the automated manufacturing system 30 in FIG. 3 is in that bridge device 43 further includes a clock generating unit 431. The clock generating unit 431 is coupled to the bridge controller 132. The lock generating unit 431 is further coupled to the mode select pin MS2 of the second transmission interface 136. The clock generating unit 431 is used for providing a clock signal have certain duty period to the mode select pin MS2. The mode select unit 134 of the bridge device 43 only outputs the mode select signal to the mode select pin MS2 of the second transmission interface 136.

To put it concretely, the bridge controller 132 may drive the mode select unit 134 output the mode select signal responsive to the received manufacturing command to the mode detection pin MD1 of the third transmission interface 151 through mode select pin MS1 and the bus 433c. The bridge controller 132 at same time drive the clock generating unit 431 to synchronously generate and output a clock signal having a specific period to the mode detection pin MD2 of the third transmission interface 151 through the mode select pin MS2 and the bus 433d.

The mode detection unit 1521 may thus synchronously receive the clock signal having a specific period and the mode select signal respectively from the mode detection pin MD2 and the mode detection pin MD1. The mode detection unit 1521 may thus determine the corresponding operating mode switching instruction based on the variation of the mode select signal (such as voltage level variation) within the specific period of the clock signal using the predefined buil-in look-up table and to drive the storage device 15 entering the corresponding operating mode.

Alternatively, the mode select unit 134 may through configuring the voltage variation pattern of the mode select signal drive the storage device 15 entering various operating modes. The mode detection unit 1521 can based on the detected voltage variation or frequency pattern of the mode select signal within a single period of the clock signal determines the corresponding operating mode switching instruction. The flash controller 152 further drives the storage device 15 into the corresponding operating mode according to the identified operating mode switching instruction.

In one implementation, taking the low-level format mode as an illustrative example. The bridge controller 132 initially controls the power control unit 132 cease supplying power to the storage device 15. After sequentially delayed for the first predetermined period and the second predetermined period, the bridge device 43 drives the power control unit 133 to start supplying power to the storage device 15. Meanwhile, the bridge controller 132 synchronously drive the mode select unit 134 and the clock generating unit 431 to generate and output the mode select signal responsive to low-level format mode (e.g., high frequency signal) and the clock signal having specific period to the storage device 15. Specifically, the mode select unit 134 outputs the mode select signal responsive to low-level format mode (e.g., high frequency signal) in correspondence to the clock signal having specific period to the storage device 15. Accordingly, the mode detection unit 1521 may thus detect and identify the mode select signal indicating the low-level format mode switching instruction according to the predefined look-up table file stored in the flash controller 152. The flash controller 152 therefore drives the storage device 15 into the low-level format mode.

It is worth to note that, the clock generating unit 431 can be removed from the bridge device 43. Alternatively, the bridge device 43 may drive the mode select unit 134 to output the mode select signal to the mode detection pin MD1 in correspondence to the clock of an internal clock unit (not shown) in the flash controller 152. In other words, the flash controller 152 may configure the mode detection unit 1521 to detect and identifying the mode select signal according to the internal clock. Thus the bridge device 43 can achieve multiple operating mode control with only one unused pin of the second transmission interface 136.

Moreover, the rest of system operation and structure of the automated manufacturing system 40 is essentially the same as the automated manufacturing system 30. Based on the above elaborations, those skilled in the art should be able to understand the operation of the automated manufacturing system 40 as well as deduce other configurations of the automated manufacturing system structures, and further descriptions are hereby omitted.

Additionally, although the instant embodiment uses pin P1 and P2 from the SATA interface as the mode select pin MS1 and mode select pin MS2 for outputting the mode select signal, however in practice, any two pins from P13˜P15 can be used as the mode select pins through firmware configuration and the present disclosure is not limited thereto.

Similarly, Although SATA interface standard is specifically illustrated in the instant embodiment for the second transmission interface 131 and the third transmission interface 151, it is appreciated that the described pin configuration concept can be easily applied to other interface standard such as the eSTATA interface standard, micro SATA interface standard, or Small Computer System Interface (SCSI) standard. FIG. 4 only serves as an illustration of a system block diagram for an automated manufacturing system and the present disclosure shall not be limited hereto.

(An Exemplary Embodiment of Automated Manufacturing System for Manufacturing Storage Device)

The disclosed automated manufacturing system may automatically perform manufacturing processes to a plurality of storage device 15 at same time so as to mass produce storage device 15.

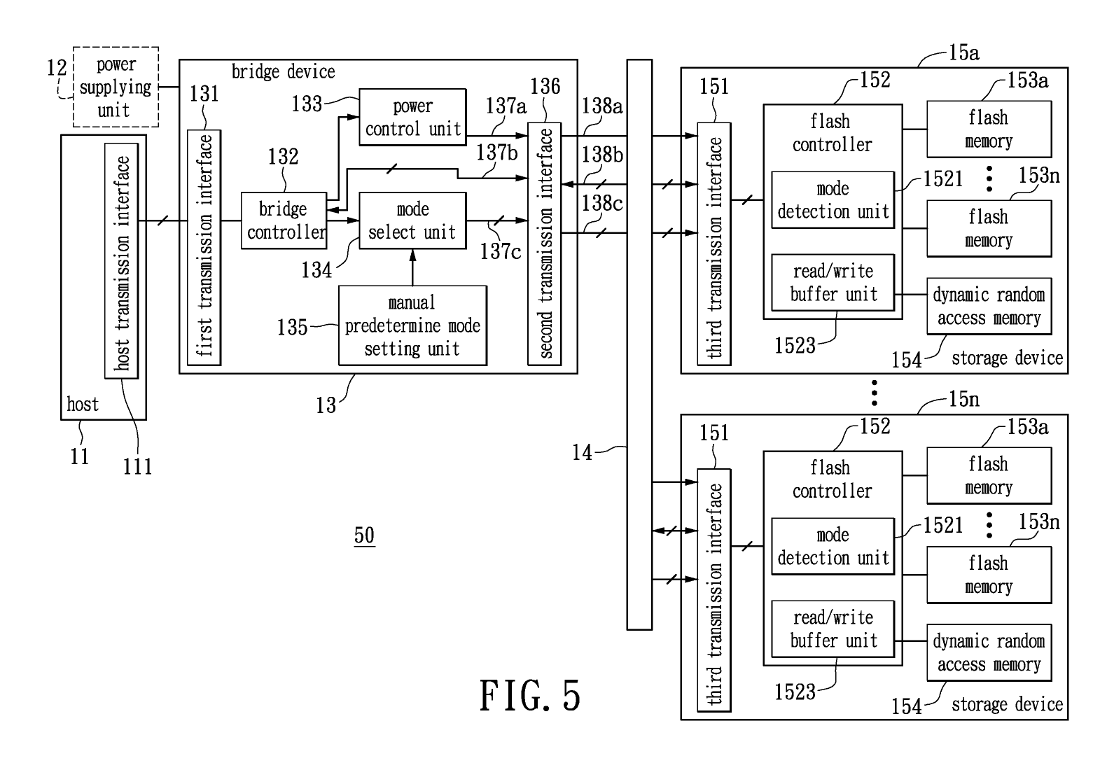

Please refer to FIG. 5 in conjunction to FIG. 1, in which FIG. 5 shows a block diagram illustrating an automated manufacturing system for manufacturing multiple storage device provided in accordance to another exemplary embodiment of the present disclosure.

The basic structure and operation theory of the automated manufacturing system 50 of FIG. 5 is the same as the automated manufacturing system 10 of FIG. 1. The difference between the automated manufacturing system 50 in FIG. 5 and the automated manufacturing system 10 in FIG. 1 is that the automated manufacturing system 50 includes a host 11, a bridge device 13, a hub 14, and a plurality of storage device 15a˜15n. The host 11 is coupled to the ridge device 13. The bridge device 13 is coupled to the hub 14. The plurality of storage device 15a˜15n is coupled to the hub 14.

When the host 11 detect the presence of at least one storage device from the plurality of storage device 15a˜15n through the bridge device 13, the operator of the host 11 may issues a manufacturing command according to the manufacturing process flow and output to the bridge device 13 via the host transmission interface 111. The bridge device 13 upon receives the manufacturing command detects whether or not the connected storage device (i.e. storage device 15a˜15n) is ready for the execution of the manufacturing process associated with the manufacturing command e.g., determining the current operating mode of the storage device 15a˜15n.

When the bridge controller 132 of the bridge device 15 determines that the connected storage device 15a˜15n are able to perform the manufacturing process in corresponding to the manufacturing command, instantly notify the host 11 to continue the related manufacturing process. The bridge device 15 transfers the data (e.g., read/write data and firmware) from the host 11 to the connected storage device 15a˜15n. Conversely, when the bridge controller 132 of the bridge device 13 determines that the connected storage device 15a˜15n are unable to execute the manufacturing process associated with the manufacturing command, the bridge controller 132 automatically drive the storage device 15a˜15n entering the corresponding operating mode so as to perform the manufacturing process.

In particular, the bridge controller 132 may control the power control unit 133 to cut off the power supplied to the storage device 15a˜15n through the hub 14 to have the storage device 15a˜15n into completely power-off state so as to reset the storage device 15a˜15n. Subsequently, after delayed for a predetermined period, the bridge controller 132 controls the mode select unit 134 through at least an unused pin of the second transmission interface 136 outputting a mode select signal to the corresponding pins of the third transmission interface 151 of the storage device 15. Meanwhile, the bridge controller 132 controls the power control unit 133 to start powering the storage device 15. When the flash controller 152 restarts, the flash controller 152 detects and identifies the mode select signal to generate corresponding operating mode switching instruction. The flash controller 152 can then drive the storage device 15 entering the appropriate operating mode in corresponding to the manufacturing command so as to execute the insturcted manufacturing process.

The rest of system operation and structure of the automated manufacturing system 50 is essentially the same as the automated manufacturing system 10. Based on the above elaborations, those skilled in the art should be able to understand the operation of the automated manufacturing system 50 and further descriptions are hereby omitted.

It is worth to note that the actual number of the storage device 15a˜15n in practice depends upon the actual manufacturing demand. The formatting of the mode select signal may depend on firmware design as well as the actual interface standard adopted for the second transmission interface 136 and the third transmission interface 151. Therefore, FIG. 5 only serves as an illustration of a system block diagram for an automated manufacturing system and the present disclosure shall not be limited hereto.

(An Exemplary Embodiment of Automated Manufacturing Method for Manufacturing Storage Device)

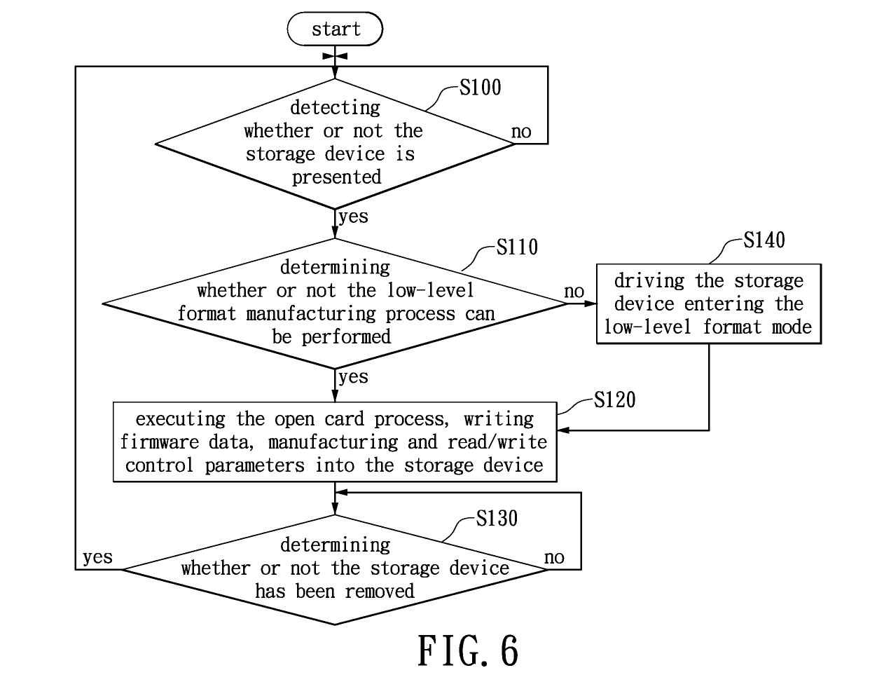

From the aforementioned exemplary embodiments, the present disclosure may generalize an automated manufacturing method for the automated manufacturing system illustrated in the aforementioned embodiment. Please refer to FIG. 6 in conjunction to FIG. 1. FIG. 6 illustrates an automated manufacturing method provided in accordance to one exemplary embodiment of the present disclosure.

In Step S100, the host 11 starts the automated manufacturing program driving the bridge device 13 detects the presence of the storage device 15. Specifically, the bridge controller 132 of the bridge device 13 has a programmable production control program. When the programmable production control program executes, the bridge device 13 actively detect the connection status of the second transmission interface 136 so as to detect the presence of the storage device 15. When the bridge device 13 detects that the storage device is connected to the second transmission interface 136, notifies the host 1 instantly through the first transmission interface 131 and executes the Step S110. Conversely, when the bridge device 13 does not detect the presence of the storage device, return to Step S100 continue detecting the connection status of the second transmission interface 136.

It is worth to note that the second transmission interface 136 has hot plugging capability therefore can constantly detecting the connection status of the second transmission interface 136 and notifying the host 11 instantly when detects the presence of the storage device 15 so as to perform the corresponding manufacturing process.

In Step S110, the host 11 detects the current state (e.g., operating mode) of the storage device 15 through the bridge device 13 to determine whether or not the low-level format manufacturing process (i.e., the open card manufacturing process) can be performed on the storage device 15. If the bridge controller 132 of the bridge device 13 determines that the low-level format manufacturing process can be performed on the storage device 15 executes Step S120. Conversely, if the bridge controller 132 of the bridge device 13 determines that the storage device 15 currently is unable to proceed with the low-level format manufacturing process, executes Step S140.

In one implementation, the host 11 may transmit a manufacturing command responsive to the low-level format manufacturing process (i.e., the low-level format manufacturing command) to the bridge device 13 via the host transmission interface 111. The programmable production control program of the bridge controller 132 may instantly output a mode verification signal to the storage device 15 through the second transmission interface 136, the bus 138c, and the third transmission interface 151. The flash controller 152 of the storage device 15 may response with an operating mode signal indicating the current operating mode to the bridge device 13 through at least a bus 138b (e.g., data bus line).

When the programmable production control program of the bridge controller 132 determines that the storage device 15 can execute the low-level format manufacturing process (i.e. the storage device 15 operates in the low-level format mode) according to the operating mode signal, notifies the host 11 proceed with the low-level format manufacturing process, i.e., firmware downloading and control and manufacturing parameters writing operations. Conversely, if no response has been received by the bridge device 13 within a certain time interval or the operating mode signal indicating that the storage device 15 is in normal mode, the bridge controller 132 forces the storage device 15 to enter the low-level format mode.

In Step S120, the automated manufacturing program of the host 11 drives the bridge controller 132 of the bridge device 13 performing the low-level format process to the storage device 15. In other words, the automated manufacturing program of the host 11 drive the bridge controller 132 of the bridge device 13 writing related firmware, manufacturing and control parameters onto the flash controller 152 of the storage device 15.

Subsequently, in Step S130, the automated manufacturing program of the host 11 drives the bridge controller 132 of the bridge device 13 detecting whether or not the storage device 15 has been removed upon completion of low-level format manufacturing process. If the bridge controller 132 of the bridge device 13 detects that the storage device 15 has been removed, executes Step S100, otherwise executes Step S130.

In Step S140, the bridge controller 132 of the bridge device 13 drives the storage device 15 into the low-level format mode so as to perform the low-level manufacturing process.

The present embodiment further generalizes two implementation methods for driving the storage device 15 into the low-level format mode.

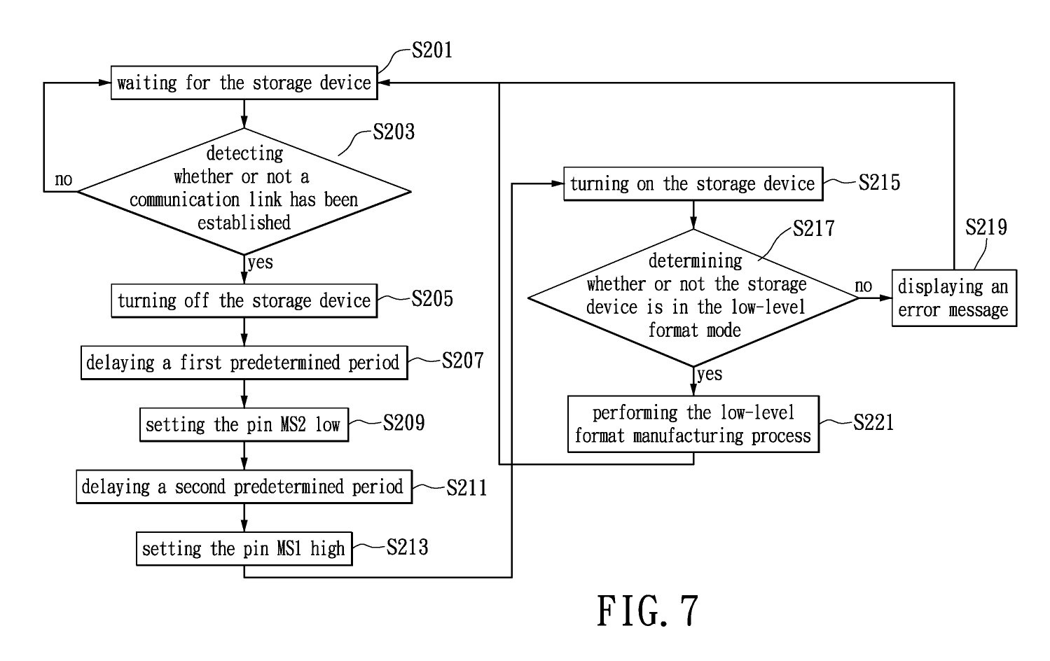

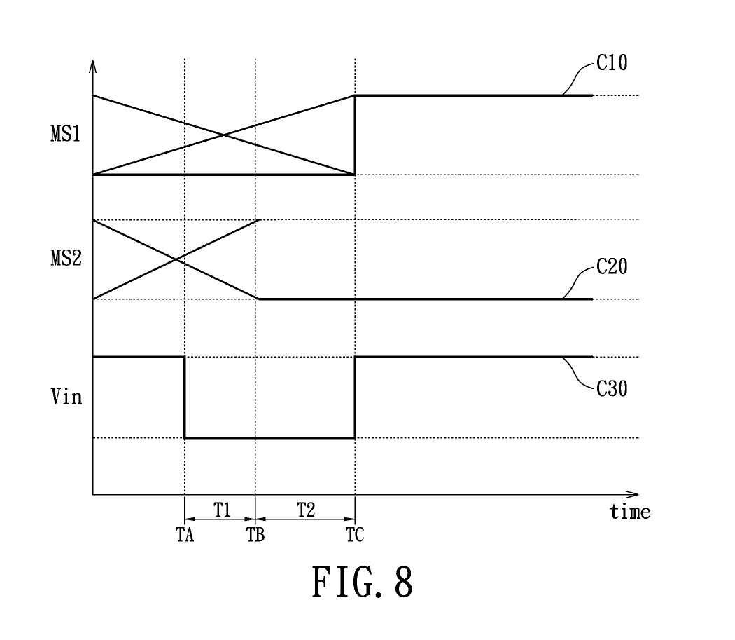

Please refer to FIG. 7 and FIG. 8 in conjunction with FIG. 3. FIG. 7 shows a low-level format mode enforcing method provided in accordance to one exemplary embodiment of the present disclosure. FIG. 8 shows a timing diagram illustrating the method described in FIG. 7 provided in accordance to the exemplary embodiment of the present disclosure. Curve C10 of FIG. 8 represents the voltage signal outputted by the mode select pin MS1. Curve C20 of FIG. 8 represents the voltage signal outputted by the mode select pin MS2. Curve C30 of FIG. 8 represents the power status of the flash controller 152 of the storage device 15.

In the instant embodiment, the second transmission interface 136 of the bridge device 13 and the third transmission interface 151 of the storage device 15 adopt the SATA interface standard. In which pin P1 and pin P2 from the unused pins of the second transmission interface 136 can be configured as the mode select pin MS1 (i.e., the first mode select pin) and the mode select pin MS2 (i.e., the second mode select pin) through firmware writing in the bridge controller 132; pin P1 and pin P2 from the unused pins of the third transmission interface 151 can be configured as mode detection pin MD1 (i.e., the first mode detection pin) and mode detection pin MD2 (i.e., the second mode detection pin) through firmware writing in the flash controller 152.

In Step S201, the host 11 waits for the present of the storage device 15 through constant detection. and Step 203, the host 11 transmits a manufacturing command to the bridge device 13 and drives the bridge controller 132 of the bridge device 13 detecting whether the storage device 15 has established communication link with the bridge device 13 e.g., detecting the transmission status of the signal buses of the interface to determine the connection status.

When the bridge controller 132 is unable to detect the commination link between the bridge device 13 and the storage device 15, returns to Step S201. Conversely, when the bridge controller 132 detects the commination link between the bridge device 13 and the storage device 15 has been established while the system of the storage device 15 is stable, executes Step S205.

In Step S205, the host 11 drive the bridge controller 132 instantly (time point TA of FIG. 8) turning off the storage device 15 as depicted by curve C30 at time point TA. The bridge controller 132 can instantly control the power control unit 133 stop powering the storage device 15 and drive the flash controller 152 of the storage device 15 into completely power-off state so as to reset the flash controller 152 of the storage device 15.

It is worth to note that during the time interval between TA of FIG. 8 and TC of FIG. 8, regardless the current state of the mode select pins MS1 and MS2, the bridge controller 132 controls the power control unit 133 cease powering the storage device 15 upon receiving the low-level manufacturing command.

In Step S207, the bridge controller 132 delays a first predetermined period T1, e.g., 1 sec to have the flash controller 152 of the storage device 15 completely power down.

In Step S209, the bridge controller 132 of the bridge device 13 controls the mode select unit 134 setting the mode select pin MS2 low (e.g., (ground level) as depicted by the Curve C20 of FIG. 8 at time point TB. That is the voltage level of the mode detection pin MD2 of the third transmission interface 151 is low.

Next in Step S211, the bridge controller 132 delays a second predetermined period T2 e.g., 1 sec, waiting for the voltage at the mode detection pin MD2 to stabilize. The second predetermined period T2 may correspond to the rising time of voltage at the mode detection pin MD2.

In Step S213, the bridge controller 132 of the bridge device 13 controls the mode select unit 134 setting the mode select pin MS1 high e.g. VCC level as illustrated by the Curve C30 at time point TC. That is the voltage level of the mode detection pin MD1 of the third transmission interface 151 is high. The power level can be configured according to the interface standard of the third transmission interface 151. Taking SATA interface standard as an example, the VCC level may be 5V.

In Step S215, the bridge controller 132 drives the power control unit 133 to start supplying power to storage device 15. When the flash controller 152 of the bridge device 15 at start up detects the voltage level of the mode detection pins MD1 and MD2 so as to identify the corresponding operating mode instruction. In the instant embodiment, when the voltage of the mode detection pin MD1 is at high voltage level while the mode detection pin MD2 is at low voltage level. Accordingly, the flash controller 152 identifies the operating mode switching instruction as the low-level format operating mode and drives the storage device 15 entering the low level format mode.

To put it concretely, the flash controller 152 may through the mode detection unit 1521 detects the voltage at the mode detection pins MD1, MD2 and identifies the corresponding operating mode switching instruction according to the predefined look-up table.

The host 11 may control the bridge device 13 through the second transmission interface 136 and bus 138c transmitting a mode verification signal to the storage device 15 to verify the current operating mode of the storage device 15. When the host 11 determines that the storage device 15 operates in the low-level format mode) according to the operating mode signal, executes Step S221. Conversely, if the host 11 receives no response from the storage device 15 within a predetermined time interval or the operating mode signal indicating that the storage device 15 is in normal mode, executes Step S219.

In Step S219, the manufacturing process control interface of the host display an error message and executes Step S201. In Step S221, the host 11 writes the firmware, control and manufacturing parameters onto the flash controller 152 of the storage device 15 through the bridge controller 132 of the bridge device 13 so as to execute the low-level format manufacturing process.

It is worth to note that the first predetermined period T1 and the second predetermined period T2 may be configured by the operator on the manufacturing process control interface provided by the host 11 according to the type and the operating status associated with the storage device 15 and pre-loaded into the bridge controller 132 of the bridge device 13

The mode select pin MS1 and the mode select pin MS2 are selected from the unused pins of the second transmission interface 136. In particular, the mode select pin MS1 and the mode select pin MS2 are configured and defined in the firmware of the bridge controller 132. Similarly, the mode detection pin MD1 and the mode detection pin MD2 are selected from the unused pins of the third transmission interface 151. In particular, the mode detection pin MD1 and the mode detection pin MD2 are configured and defined in the firmware of the flash controller 152.

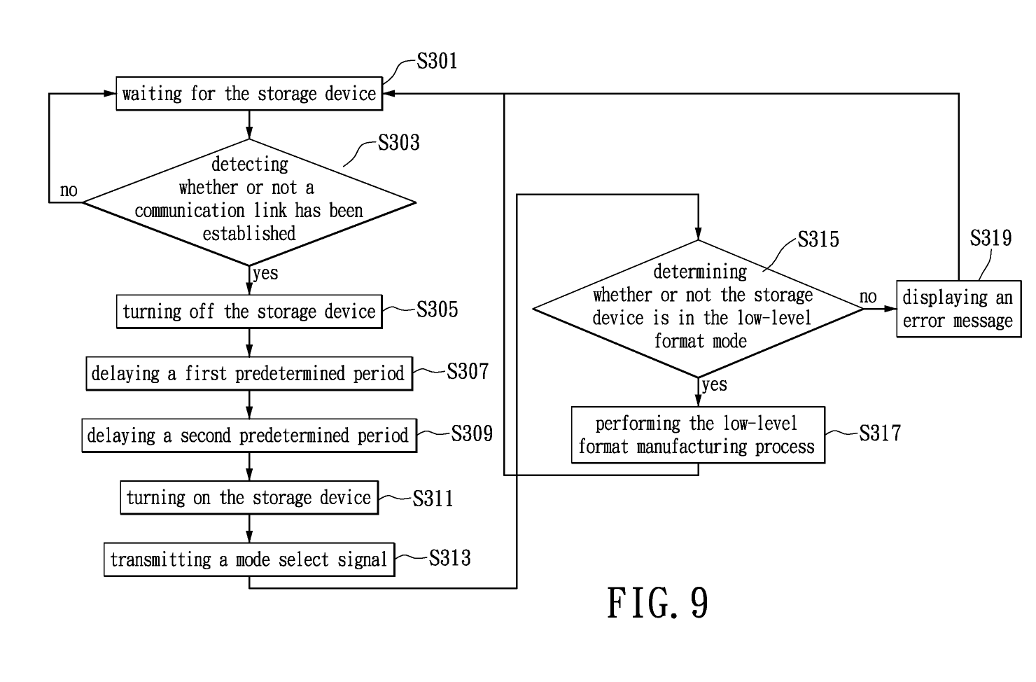

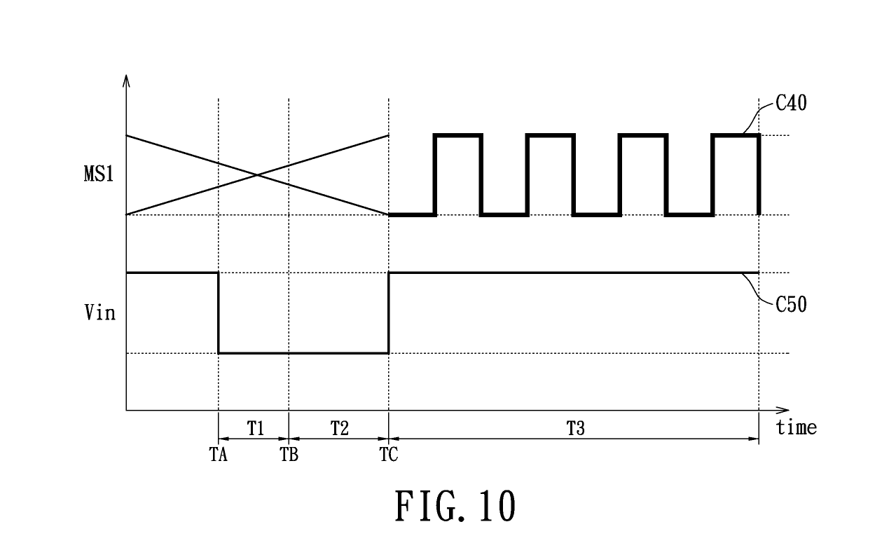

Please refer to FIG. 9 and FIG. 10 in conjunction to FIG. 1. FIG. 9 depicts another low-level format mode enforcing method provided in accordance to another exemplary embodiment of the present disclosure. FIG. 10 is a timing diagram illustrating the method described in FIG. 9 provided in accordance to the exemplary embodiment of the present disclosure. Curve C40 of FIG. 10 represents the voltage signal outputted by the mode select pin MS1. Curve C50 of FIG. 10 represents the power status of the flash controller 152 of the storage device 15.

In Step 301, the host 11 waits for the presence of the storage device 15 through constant detection. In Step 303, the host 11 transmits a manufacturing command to the bridge device 13 via the host transmission interface 111 and drives the bridge controller 132 of the bridge device 13 detecting whether the storage device 15 has established communication link with the bridge device 13 e.g., detecting the transmission status of the signal buses of the interface to determine the connection status.

When the bridge controller 132 is unable to detect the commination link between the bridge device 13 and the storage device 15, returns to Step S301. Conversely, when the bridge controller 132 detects the commination link between the bridge device 13 and the storage device 15 has been established while the system of the storage device 15 is stable, executes Step S305.

In Step S305, the host 11 drive the bridge controller 132 instantly (time point TA of FIG. 8) turning off the storage device 15 as depicted by curve C30 at time point TA. The bridge controller 132 can instantly drive the power control unit 133 stop powering the storage device 15 and drive the flash controller 152 of the bridge device 15 into completely power-off state so as to reset the flash controller 152 of the bridge device 15.

In Step S307, the bridge controller 132 delays a first predetermined period T1, e.g., 1 sec to have the flash controller 152 of the storage device 15 completely power down. In Step S309, the bridge controller 132 delays a second predetermined period T2 e.g., 1 sec, and waits for the voltage at the mode detection pin MD2 to stabilize. In Step S311, the bridge controller 132 drives the power control unit 133 to start supplying power to storage device 15.

In Step 313, at time point TC, the bridge controller 132 of the bridge device 13 drives the mode select unit 134 outputting a mode select signal through the mode select pin MS1 of the second transmission interface 136 to the mode detection pin MD1 of the third transmission interface 151 within the third predetermined period T3. The mode select signal in the instant embodiment may be a high frequency clock signal. The third predetermined period T3 can be predefined in the flash controller 152 via firmware design.

At start up, the flash controller 152 of the bridge device 15 detects the frequency of the mode select signal received at the mode detection pin MD1 and MD2. The flash controller 152 then identifies the associated operating mode switching instruction as being a high frequency signal indicating the low-level format mode switching instruction. Subsequently, the flash controller 152 correspondingly drives the storage device 15 entering the low level format mode.

In Step S315, the host 11 may drive the bridge device 13 through the second transmission interface 136 and bus 138c transmitting a mode verification signal to the storage device 15 to verify the current operating mode of the storage device. When the host 11 determines that the storage device 15 operates in the low-level format mode) according to the operating mode signal, executes Step S317. Conversely, if the host 11 receives no response from the storage device 15 within a predetermined time interval or the operating mode signal indicating that the storage device 15 is in normal mode, executes Step S319.

In Step S319, the manufacturing process control interface of the host 11 display an error message and executes Step S301. In Step S317, the host 11 writes the firmware, control and manufacturing parameters onto the flash controller 152 of the storage device 15 through the bridge controller 132 of the bridge device 13 to perform low-level format manufacturing process. After completion of the low-level format manufacturing process, returns to Step S301

In practice, the signal pattern associated with the mode select signal are predefined in the look-up table files stored in the bridge controller 132 of the bridge device 13 and the flash controller 152 of the storage device 15. The predefined look-up table file stored in the bridge controller 132 may include the mode select signal, corresponding operating mode, and the associated manufacturing process. The look-up table file stored in the flash controller 15 may include the mode select signal and the corresponding operating mode switching instruction. The mode select signal may a clock signal having different frequency or pulse pattern or the mode select signal may be a constant signal with high or low voltage level so long as the bridge controller 132 of the bridge device 13 and the flash controller 152 of the storage device 15 can understand the meaning of the mode select signal, and the present disclosure is not limited thereto.

The first transmission interface 131 of the bridge device 13 is compatible with the host transmission interface 111 of the host 11. The type of the host transmission interface 111 and the first transmission interface 131 may include but not limited to universal serial bus (USB) interface, an IEEE 1394 interface, a SATA interface, an eSATA interface, and a micro SATA interface.

The second transmission interface 136 of the bridge device 13 is compatible with the third transmission interface 151 of the storage device 15. The type of the second transmission interface 136 and the third transmission interface 151 may include but not limited to an integrated drive electronic (IDE) standard, a SATA standard, a micro SATA standard, a Small Computer System Interface (SCSI) stands, a flash interface standard, or a ZIP standard. It shall be noted that the actual type and implementation method of the host transmission interface 111, the first transmission interface 131, the second transmission interface 136, and the third transmission interface 151 depend upon the specific design and/or operational requirement and shall not be limited to the examples provided by the instant embodiment.

Although the instant embodiment describes driving the storage device 15 into low-level format mode for performing low-level format mode manufacturing process as an example, it is appreciated that the method illustrated by FIG. 6˜FIG. 10 may be applied to drive the storage device 15 into other operating modes including normal mode, high performance mode or green power mode to perform various manufacturing processes and the present disclosure is not limited thereto.

Based on the above elaborations, those skilled in the art should be able to infer the mode select signal implementation method and various operating mode driving method and further descriptions are hereby omitted. FIG. 6-10 only serves as an illustration for explaining the automated manufacturing method and the present disclosure shall not be limited hereto.

(An Exemplary Embodiment of Automated Manufacturing System Initialization Method)

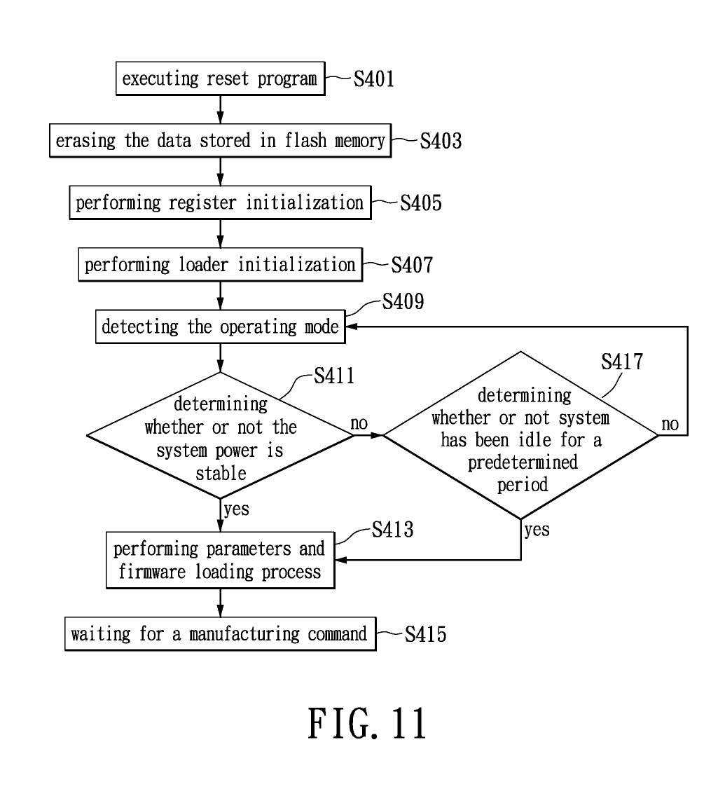

Please refer to FIG. 11 in conjunction with FIG. 1, in which FIG. 11 depicts method for resetting the flash controller 152 of the storage device 15 provided in accordance to one exemplary embodiment of the present disclosure.

When the bridge controller 132 of the bridge device 13 controls the flash controller 152 of the storage device 15 into a reset operating mode using the driving method illustrated in aforementioned embodiment, the programmable production processing program of the flash controller 152 activates the reset program. (Step S401).

In Step S403, the flash controller 152 erase the memory stored in the static random access memory (SRAM), i.e., clear the memory of flash memory 153a˜153n.

In Step S405, the flash controller 152 of the storage device 15 initializes the internal register, i.e., clear the state of the register. Afterward in Step S407, initializes the loader. In Step S409, the flash controller 152 detects the current operating mode, e.g., detecting the states of the mode detection pin MD1, and MD2. In Step S411, the flash controller 152 determines whether or not the system power of the storage device is stable. For instance, the flash controller 152 may determine whether or not the supplying power received at power pins of the third transmission interface 151 is stable. If determines that the power received by the storage device 15 is unstable, executes Step 413, otherwise executes Step S417.

In Step S413, the flash controller 152 loads related parameters including the manufacturing parameters and firmware data (e.g., the pin configuration of the third transmission interface 151 or predefined look-up table file). The manufacturing parameters and firmware data may be download from the host 11 through bridge device 13, wherein the bridge device 13 converts the manufacturing parameters and firmware data into the data format that is compatible to the third transmission interface 151.

In Step S417, the flash controller 152 determines whether or not the system has been idle for a predetermined time e.g. 1 sec. If determines that the system has been idle for a predetermined time executes Step S413, otherwise, executes Step S409.

In Step S415, after the flash controller 152 completes loading the related partakers and firmware, the flash controller 152 waits for the next manufacturing command from the host 11 to perform the related manufacturing process.

FIG. 11 only serves as an illustration for explaining the reset method of the flash controller 152 and the present disclosure shall not be limited hereto.

In summary, an exemplary embodiment of the present disclosure provides a bridge device, an automated manufacturing system, and a method thereof which can through using a hardware/firmware integrated bridge device coordinate the communication between a host and at least a storage device to automatically manufacture the storage device. The bridge device, the automated manufacturing system and the method thereof may utilize firmware design control method automatically driving the storage device into various operating mode e.g., low-level format mode, normal mode, high performance or green power mode in correspondence to the manufacturing process. The present disclosure through utilize hardware/firmware designed bridge device can facilitate the automated manufacturing system in automatically performing all the necessary manufacturing processes onto the storage device at one production line without the need to manually configure the operating mode of the storage device via replacing the bridge device or modifying the hardware structure of the storage device. Consequently, the overall production efficiency can be increase while overall production complexity and cost can be reduced.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A bridge device for automatically manufacturing at least a storage device, the bridge device comprising:
a first transmission interface, coupled to a host to receive a manufacturing command generated by the host;
a second transmission interface, coupled to the storage device;
a mode select unit, coupled to the second transmission interface, outputting a mode select signal responsive to the manufacturing command;
a power control unit, controlling the powering operation of the storage device; and
a bridge controller, coupled to the first transmission interface, receiving the manufacturing command and operatively controlling the operations of the mode select unit and the power control unit according to the manufacturing command;
wherein when the bridge controller detects the presence of the storage device through the second transmission interface, the bridge controller drives the power control unit turning off the storage device, controls the mode select unit transmitting the model select signal to the storage device through at least an unused pin of the second transmission interface after a first predetermined period, and drives the power control unit turning on the storage device after a second predetermined period to have the storage device entering an operating mode according to the mode select signal so as to automatically execute a manufacturing process in corresponding to the manufacturing command.

2. The bridge device according to claim 1, wherein the operating mode is a low-level format mode, a normal mode, a high performance mode, or a power saving mode.

3. The bridge device according to claim 1, wherein the model select unit transmits the mode select signal with a specific voltage level through an unused pin of the second transmission interface to configure the operating mode of the storage device so as to execute the corresponding manufacturing process.

4. The bridge device according to claim 1, wherein after the first predetermined period, the mode select unit outputs a low voltage level to the storage device through a second mode select pin of the unused pins of the second transmission interface; after the second predetermined period, the mode select unit outputs a high voltage level signal to the storage device through a first model select pin of the unused pins of the second transmission interface for generating the mode select signal driving the storage device entering a low-level format mode.

5. The bridge device according to claim 1, wherein the bridge device further comprises:
a voltage level shifting unit, coupled to the mode select unit, transforming the voltage level of the mode select signal to the voltage level compatible with the operating voltage of the storage device; and
a current and voltage drop limiting unit, coupled to the voltage level shifting unit, limiting the outputted current of the unused pins of the second transmission interface.

6. The bridge device according to claim 1, wherein the first transmission interface comprises of a universal serial bus interface, an IEEE 1394 interface, a SATA interface, an eSATA interface, or a micro SATA interface.

7. The bridge device according to claim 1, wherein a flash controller of the storage device identifies the received model select signal using a look-up table file to correspondingly drive the storage device into the operating mode and execute the manufacturing process.

8. An automated manufacturing system, comprising:
a host, generating a manufacturing command;
at least a storage device; and
a bridge device, coupled between the host and the storage device, the bridge device comprising:
a first transmission interface, coupled to the host;
a second transmission interface, coupled to the storage device;
a mode select unit, coupled to the second transmission interface, outputting a mode select signal responsive to the manufacturing command;
a power control unit, controlling the powering operation of the storage device; and
a bridge controller, coupled to the first transmission interface, receiving the manufacturing command and operatively controlling the operations of the mode select unit and the power control unit according to the manufacturing command;
wherein when the bridge controller detects the presence of the storage device through the second transmission interface, the bridge controller drives the power control unit turning off the storage device, controls the mode select unit transmitting the model select signal to the storage device through at least an unused pin of the second transmission interface after a first predetermined period, and drives the power control unit turning on the storage device again after a second predetermined period to have the storage device entering an operating mode according to the mode select signal so as to automatically execute a manufacturing process in corresponding to the manufacturing command.

9. The automated manufacturing system according to claim 8, wherein the operating mode is a low-level format mode, a normal mode, a high performance mode, or a power saving mode.

10. The automated manufacturing system according to claim 8, wherein the first transmission interface is used to establish communication between the host and the bridge device and the second transmission interface is used to establish communication between the bridge device and the storage device.

11. The automated manufacturing system according to claim 8, wherein the storage device further comprises:
a third transmission interface, couple to the second transmission interface, the third transmission interface receiving the mode select signal through at least an unused pin thereof; and
a flash controller, comprising a mode detection unit, the a mode detection unit of the flash controller detecting and identifying the mode select signal, the flash controller further driving the storage device into the corresponding operating mode based on the mode select signal.

12. The automated manufacturing system according to claim 11, wherein the interface standard of the second transmission interface is compatible to the interface standard of the third transmission interface, the interface standards of the second transmission interface and the third transmission interface comprising at least a communication standard of an integrated drive electronic (IDE) standard, a SATA standard, a micro SATA standard, a Small Computer System Interface (SCSI) standard, a flash interface standard, or a ZIP standard.

13. The automated manufacturing system according to claim 8, wherein the storage device comprises a type of a hard disk drive, a solid state disk drive, a hybrid disk drive, an optical disk drive, a magnetic optic drive, a flash disk, a phase change disk, a PCI express, a secure digital card, a memory stick, a compact flash, an embedded multimedia card (eMMC), an integrated drive electronic flash memory, or a SATA flash device.

14. An automated manufacturing method for manufacturing at least a storage device, adapted for an automated manufacturing system, wherein the automated manufacturing system comprises a host, at least a storage device, and a bridge device coupled between the host and the storage device, the automated manufacturing method comprising:
the bridge device detecting whether or not the storage device is connected to the bridge device and executing a manufacturing command when the storage device is connected to the bridge device;
the bridge device detecting whether or not a manufacturing process in corresponding to the manufacturing command can be performed;
the bridge device transmitting a mode select signal driving the storage device entering an operating mode when the storage device is unable to execute the manufacturing process; and
the bridge device loading the data sent by the host into the storage device when the storage device has entered the operating mode in corresponding to the manufacturing command so as to have the storage device executing the manufacturing process.

15. The automated manufacturing method according to claim 14, wherein the step of having the bridge device transmitting the mode select signal comprises:
ceasing powering the storage device;
delaying a first predetermined period to completely turn off the storage device;
transmitting the mode select signal to the storage device through at least unused pin of the transmission interface of the bridge device; and
delaying a second predetermined period to start supplying power to the storage device;
wherein when the storage device restarts, the storage device enters the operating mode responsive to the mode select signal to execute the manufacturing process.

16. The automated manufacturing method according to claim 15, wherein the mode select signal is a high voltage level signal, a low voltage level signal, or a high frequency clock signal.

17. The automated manufacturing method according to claim 15, wherein the step after the storage device entered the operating mode comprises:
the bridge device detecting whether the storage device has entered the operating mode; and
when the bridge device detects that the storage device has not entered the operating mode, re-executes the steps of ceasing powering the storage device, mod select signal transmission, restarting the storage device to have the storage device entering the operating mode.

18. The automated manufacturing method according to claim 15, wherein when the manufacturing command is a low-level format command and the operating mode of the storage device is in the low-level format mode, the host writes the firmware data, read/write parameters and manufacturing parameters into the flash controller of the storage device through the bridge device.

19. The automated manufacturing method according to claim 15 wherein the step of the storage device detecting the mode select signal comprises:
searching for the received mode select signal within the predefined look-up table file;
when a match being found within the look-up table file, obtaining a corresponding operating mode switching instruction associated with the mode select signal; and
executing the operating mode switching instruction to drive the storage device entering the operating mode.

20. The automated manufacturing method according to claim 15, wherein the host generates a manufacturing process configuration interface providing user-configurations for the corresponding manufacturing process of the storage device through executing a programmable manufacturing program code.
